(19) United States
(12) Patent Application Publication
(10) Pub. No.: US 2022/0389893 A1
(43) Pub. Date: Dec. 8, 2022

(54) FUEL SYSTEM WITH VAPOR MANAGEMENT

(71) Applicant: Walbro LLC, Cass City, MI (US)

(72) Inventor: Edward J. Talaski, Caro, MI (US)

(21) Appl. No.: 17/770,081

(22) PCT Filed: Nov. 5, 2020
(86) PCT No.: PCT/US2020/059085

§ 371 Date: Apr. 19, 2022

Related U.S. Application Data
(60) Provisional application No. 62/930,751, filed on Nov. 5, 2019.

(51) Int. Cl. F02M 37/54; F02M 37/18; F02M 37/44; F02M 37/20

(52) U.S. Cl. CPC F02M 37/54; F02M 37/18; F02M 37/44; F02M 37/20

(57) ABSTRACT

A fuel system, including a first pump, a second pump and a filter module. The filter module has a housing defining an interior, a filter received in the interior, a filter inlet through which fluid flows into the interior, a filter outlet from which fluid flows out of the interior, and a vent body received within the interior. The vent body has a passage and a vent orifice. The filter is arranged so that fluid that enters the filter inlet flows through the filter before flowing out of the filter outlet and the interior includes an upper portion arranged above a lower portion relative to the force of gravity, and the passage communicates with the filter outlet and with the lower portion of the interior and the vent orifice communicates with the passage and with the upper portion of the interior.

### REFERENCE TO RELATED APPLICATIONS

This application claims the benefit of U.S. Provisional Application Ser. No. 62/930,751 filed on Nov. 5, 2019 the entire content of which is incorporated herein by reference in its entirety.

### TECHNICAL FIELD

The present disclosure relates generally to a fuel system with vapor management.

### BACKGROUND

In liquid fuel systems, fuel vapor may be generated and vapor and air may be drawn into a fuel pump from which fuel is delivered to an engine. The vapor or air flowing in the system reduces the volume of liquid fuel flowing in the system, and can negatively impact operation of the fuel pump and engine.

### SUMMARY

A fuel system, including a first pump, a second pump and a filter module. The first pump has a first pump inlet, a first pump outlet and a first pump pumping element between the first pump inlet and first pump outlet. The second pump has a second pump inlet, a second pump outlet and a second pump pumping element between the second pump inlet and second pump outlet. And the filter module has a housing defining an interior, a filter received in the interior, a filter inlet through which fluid flows into the interior, a filter outlet from which fluid flows out of the interior, and a vent body received within the interior. The vent body has a passage and a vent orifice. The filter is arranged so that fluid that enters the filter inlet flows through the filter before flowing out of the filter outlet and the interior includes an upper portion arranged above a lower portion relative to the force of gravity, and the passage communicates with the filter outlet and with the lower portion of the interior and the vent orifice communicates with the passage and with the upper portion of the interior.

In at least some implementations, the vent orifice has a smaller flow area than does the passage. In at least some implementations, the passage opens into the interior at a location below a vertical midpoint of the interior, where the vertical midpoint is determined in the direction of the force of gravity. In at least some implementations, the vent orifice opens into the interior at a location above a vertical midpoint of the interior, where the vertical midpoint is determined in the direction of the force of gravity. The vent orifice may have a cross-sectional area between 10 and 50 times smaller than the cross-sectional area of the passage.

In at least some implementations, the filter is annular and wherein the filter inlet communicates directly with an outer surface of the filter and the filter outlet communicates directly with an inner surface of the filter. In at least some implementations, the vent body is tubular and received within a space defined by the inner surface of the filter. The vent body may be secured to one or both of an upper wall of the housing and the inner surface of the filter. The vent orifice may extend through a sidewall of the vent body.

In at least some implementations, a fuel system includes a first pump having a first pump inlet, a first pump outlet and a first pump pumping element between the first pump inlet and first pump outlet, a second pump having a second pump inlet, a second pump outlet and a second pump pumping element between the second pump inlet and second pump outlet, and a vent passage communicating with the second pump inlet and either or both of the first pump inlet and the first pump outlet. Fluid flows into the first pump inlet, the first pump pumping element increases the pressure of the fluid in the first pump and that fluid is discharged from the first pump outlet, and fluid discharged from the first pump outlet flows to the second pump inlet.

In at least some implementations, a housing surrounds at least part of the first pump and defines a first pump inlet chamber with which the first pump inlet communicates, and a housing surrounds at least part of the second pump and defines a second pump inlet chamber with which the second pump inlet communicates, and the vent passage communicates with the second pump inlet chamber. In at least some implementations, the vent passage communicates with the first pump inlet chamber. In at least some implementations, the housing that defines part of the first pump inlet chamber also defines part of a first pump outlet chamber into which fluid is discharged from the first pump outlet, and the vent passage may communicate with the first pump outlet passage.

In at least some implementations, the housing that defines part of the first pump inlet chamber also defines part of a first pump outlet chamber into which fluid is discharged from the first pump outlet, and the system also includes a pressure regulator having an inlet communicated with the first pump outlet chamber, an outlet communicated with the first pump inlet chamber and a valve between the inlet of the pressure regulator and the outlet of the pressure regulator. And the valve is closed when the pressure within the first pump outlet chamber is below a threshold and the valve is open when the pressure within the first pump outlet chamber is above a threshold.

In at least some implementations, the housing surrounding at least part of the first pump and defining a first pump inlet chamber with which the first pump inlet communicates, is the same housing as the housing surrounding at least part of the second pump and defining a second pump inlet chamber with which the second pump inlet communicates.

In at least some implementations, a restriction is provided in the vent passage providing a portion of the vent passage with a smaller flow area that inhibits the flow of liquid fuel therethrough. In at least some implementations, the restriction has a minimum cross-sectional flow area, taken perpendicular to the direction of fluid flow therethrough, of between 0.3 mm² and 2.0 mm².

### BRIEF DESCRIPTION OF THE DRAWINGS

The following detailed description of certain embodiments and best mode will be set forth with reference to the accompanying drawings, in which:

FIG. 1 is a diagrammatic view of a portion of a fuel system including two fuel pumps and a fuel filter disposed between the fuel pumps;

FIG. 2 is a cross-sectional view of a fuel filter module that may be used as the fuel filter in the fuel system shown in FIG. 1;

FIG. 3 is a side view of a fuel pump assembly including two fuel pumps and a fuel filter within and/or coupled to a common housing;

FIG. 4 is a bottom view of the assembly of FIG. 3;

FIG. 5 is a view showing the housing in two pieces with a first fuel pump and a second fuel pump shown separately to illustrate a fluid flow path from the second fuel pump to the first fuel pump;

FIG. 6 is an enlarged, fragmentary sectional view of a portion of FIG. 5 showing a fuel pressure regulator;

FIG. 7 is a fragmentary sectional view of an alternate assembly including a fuel pressure regulator near an inlet chamber of the first fuel pump;

FIG. 8 is a partially sectioned side view of a fuel pump having a motor and a turbine impeller pumping element driven by the motor; and

FIG. 9 is a plan view of an inlet end cap for a fuel pump.

### DETAILED DESCRIPTION

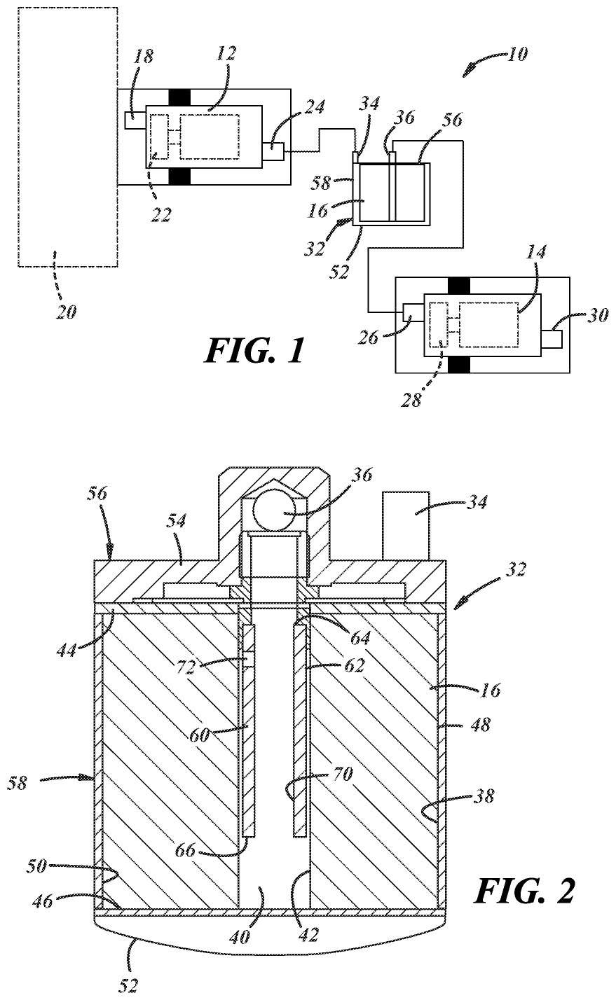

Referring in more detail to the drawings, FIG. 1 illustrates a fuel system 10 including a first fuel pump 12, a second fuel pump 14 (hereafter simply called first pump 12 and second pump 14) and a fuel filter 16 between the pumps 12, 14. As generally shown in FIG. 9, the first pump 12 has an inlet 18 communicated with a fuel tank 20 or other fuel source and liquid fuel in the fuel tank enters the first pump 12 through the inlet 18. The first pump 12 has a pumping element 22 that increases the pressure of the fuel therein and discharges the fuel under pressure through an outlet 24 of the first pump 12. The second pump 14 is arranged downstream of the first pump 12 and has an inlet 26 through which at least some of the fuel discharged from the first pump 12 flows. The second pump 14 also includes a pumping element 28 that increases the pressure of the fuel in the second pump 14 and discharges the fuel through an outlet 30 of the second pump 14 for delivery to an engine. In at least some implementations, the pressure at the outlet 24 of the first pump 12 is lower than the pressure at the outlet 30 of the second pump 14. Both fuel pumps 12, 14 may include an electric motor that rotates/drives the pumping elements 22, 28 that may include turbine type impellers, positive displacement gerotors, screws, gears or any desired pumping element. In at least some implementations, at least one of the pumps includes a positive displacement pumping element(s) that, for example, facilitates priming the pump.

The fuel filter 16 may be part of a module or assembly that has a housing 32 with an inlet 34 in communication with the outlet 24 of the first pump 12, an outlet 36 in communication with the inlet 26 of the second pump 14 and an interior chamber 38 in which the filter 16 is retained. The filter 16 may be formed from any desired material or a combination of materials, including for example, paper, polymeric foam or arranged fibers/mesh, or other material. In at least some implementations, the fuel filter 16 is an accordion or otherwise folded or pleated paper filter that is tubular or otherwise has an interior 40 defined by an inner surface 42 of the filter 16. Further, the filter 16 may be part of a cartridge that includes an upper wall 44 and a lower wall 46 that cover and close off opposed ends of the tubular filter material. In this form, the filter inlet 34 may communicate with an outer surface 48 of the filter 16 that is adjacent to an interior surface 50 of the housing 32 and the filter outlet 36 may communicate with the interior 40 of the filter 16 that is defined by the inner surface 42 of the filter 16. Thus, fuel must flow through filter 16 from the outer surface 48 to the inner surface 42 (and between the upper wall 44 and lower wall 46) before the fuel exits through the filter outlet 36. In this way, fuel that enters the filter housing 32 must pass through the filter 16 before flowing out of the filter housing 32.

In at least some implementations, the filter housing 32 is arranged so that it maintains a supply of fuel therein. For example, the housing 32 may have a lower wall 52 and the outlet 36 may communicate with the interior 38 at a location above the lower wall 52, where “above” and “lower” are relative to the direction of the force of gravity. In at least some implementations, the outlet 36 is located in or adjacent to an upper wall 54 of the housing 32 such that the housing is at least substantially filled with fuel before fuel flows out of the outlet 36. In the example shown in FIG. 2, the housing 32 includes a cover 56 that may define the upper wall 54 and which may be sealed to a bowl-shaped body 58 of the housing 32 that defines, carries or includes the lower wall 52. The interior 38 may be defined between the cover 56 and body 58 of the housing 32. The inlet 34 and outlet 36 may both be formed in the cover 56, if desired, and may be defined in part by fittings to which suitable conduits may be connected for routing fuel to and from the fuel filter 16.

While the above description noted that liquid fuel that is pumped by the first pump 12 flows to the fuel filter 16 and then to the second pump 14, the first pump 12 may also pump gaseous matter, like air and fuel vapors, that are also conveyed to housing interior 38 and the fuel filter 16 therein. At least when the filter material exhibits capillary properties such that only liquid fuel passes through the filter material when it is wet, and air does not pass through the wet filter material, the interior 40 of the filter 16 will contain only or substantially only liquid fuel that is available to the second pump 14 via the filter housing outlet 36 as the air/vapors will be maintained between the outer surface 48 of the filter 16 and the housing 32. However, without a vent or other means for removing the gaseous matter from the filter housing 32, the gaseous matter can reduce the volume within the housing interior 38 that is available for liquid fuel.

In at least some implementations, a vent body 60 may be provided that accommodates liquid and gaseous fluid flow within the housing 32. The vent body 60 may have a continuous sidewall 62 that is secured to one or both of the upper wall 44 and/or the inner surface 42 of the filter 16, an upper surface 64 at one end of the sidewall 62, and a lower surface 66 at the opposite end of the sidewall 62 that is spaced from the lower wall 46 of the filter cartridge. The vent body 60 may be tubular, received within the filter interior 40, and may further have a passage 70 that is communicated with the interior 40 of the filter 16 and the filter outlet 36, and a vent orifice 72 located between the upper and lower surfaces 64, 66 of the vent body 60. The vent orifice 72 may extend through the sidewall 62 and communicate the filter 16 with the passage 70, and hence, the filter outlet 36.

So constructed and arranged, fluid (liquid fuel and/or gaseous matter) that enters the housing 32 via the filter inlet 34 is routed to an area defined at least in part by the outer surface 48 of the filter 16. Liquid fuel flows through the fuel filter 16 and toward the bottom of the filter and a lower area of the interior 38 from which liquid fuel enters the interior 40 of the filter 16 and/or the passage 70 of the vent body 60 through the lower end or other opening in the vent body 60. Thus, fuel flows to the filter outlet 36 through the vent body passage 70 which typically is immersed in liquid fuel and spaced from gaseous matter in the housing interior 38. In this way, the filter outlet 36 may be considered as being in direct communication with the filter interior 40 and the inner surface 42 of the filter 16, and the filter inlet 34 may be considered as being in direct communication with the outer surface 48 of the filter 16. In this context, “direct communication” means that the filter material is not received between the two reference points/objects. So the filter outlet 36 is indirectly communicated with the filter inlet 34 because the filter 16 is between the inlet 34 and outlet 36

Because the filter outlet 36 is communicated with the housing interior 38 through the vent body passage 70, which extends toward the bottom of the housing interior 38 (and filter interior 40) in which liquid fuel and not gaseous matter usually resides, the amount of gaseous matter that is delivered from the filter 16 to the second pump 14 is reduced. In at least some implementations, the lower end of the vent body 60 or other opening/inlet of the passage 70 may be located below a vertical midpoint of the filter interior 40 between the lower wall 46 and the inner surface of the cover 56, where below and other such directional orientations are with regard to the direction of the force of gravity.

While liquid fuel is routed toward or tends to collect in the bottom of the housing interior 38, gaseous matter in the housing interior 38 is generally maintained or collects between the cover 56 and the liquid fuel within the interior 38, and may escape the interior by flowing through the filter 16 and then through the vent orifice 72 to the passage 70 and out of the filter outlet 36. To control the flow rate of gaseous matter that flows out of the filter housing 32, the vent orifice 72 may be relatively small, for example, between 10 and 50 times smaller than the diameter or cross-sectional area of the passage 70 (or the smallest cross-sectional portion of the passage 70 if the passage 70 has a variable cross-sectional area between its inlet and outlet). Thus, a controlled flow rate of gaseous matter may be joined with the liquid fuel flowing through the filter outlet 36. This avoids too much gaseous matter being sent to the second pump 14 at any given time to avoid any significant loss of pumping capacity of the second pump 14, and effectively provide a reserve supply of liquid fuel at the end of the vent body ready for delivery to the second pump 14, for example, after operation of the pumps has stopped and is later restarted.

In at least some implementations, the vent orifice 72 communicates or is located above the vertical midpoint of the housing interior 38, and preferably within the upper 25% of the vertical extent of the housing interior 38. Thus, the vent orifice 72 is located in an area of the interior 38 in which gaseous matter is more likely to be, and provides a controlled path through which a limited flow of gaseous matter may occur. Further, the inner passage inlet, which may be defined by the lower surface, may be located below the vertical midpoint of the housing interior 38, and may be located within a lower 25% of the vertical extent of the housing interior 38. In this way, the inlet of the passage 70 may be immersed in liquid fuel which collects in the bottom of the housing interior 38 and in the bottom of the filter interior 40. This reduces the flow of gaseous matter to the second pump 14.

While the filter described above is annular and has an inner surface that defines an interior from which fuel flows to the filter outlet 36, the filter could be otherwise arranged. In various forms or shapes, the filter 16 may be arranged so that fuel must flow through the filter 16 after the fuel enters the housing 32 through the inlet 34 and before that fuel exits the outlet 36. The vent body passage 70 may communicate with the area in the housing interior 38 that is downstream of the filter 16 and preferably also below a vertical midpoint of the housing interior 38, and the vent orifice may communicate with the interior 38 preferably above the vertical midpoint of the housing interior 38. The filter 16 could also be used in a single fuel pump system, downstream of an outlet of the single fuel pump.

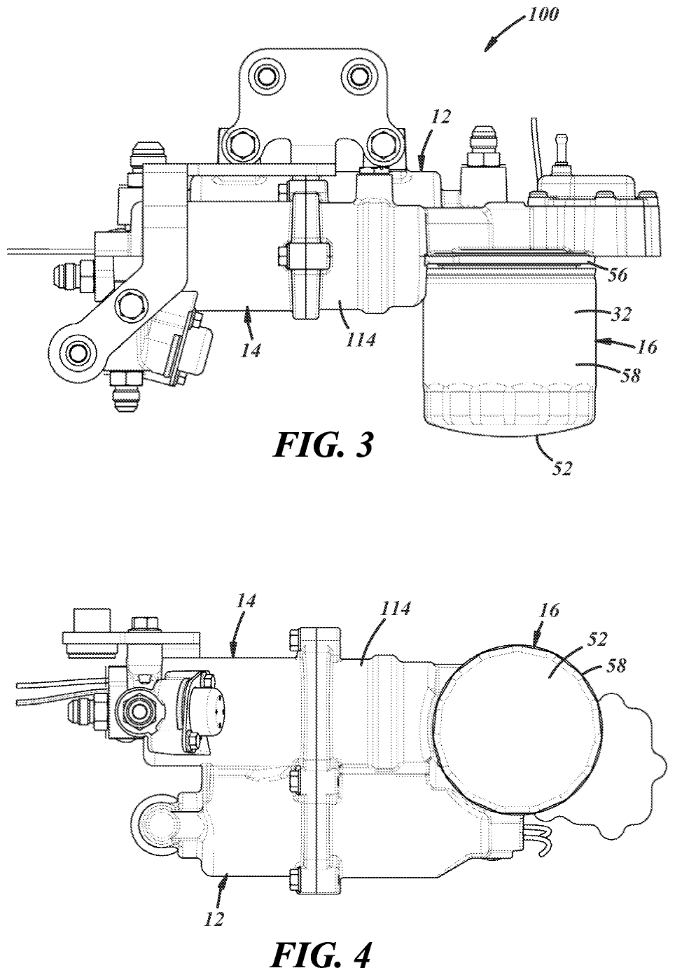

The fuel system 100 shown in FIGS. 3-5 also includes a first fuel pump 12 and a second fuel pump 14, that are also in series and which may be carried by or coupled to a common housing 114. The outlet of the first pump 12 is routed to the inlet of the second pump 14. The first pump 12 and second pump 14 may be the same as described above and use of the filter 16 between the pumps 12, 14 is optional. As noted above, the first pump 12 has an inlet 18 communicated with a fuel tank 20 or other fuel source and liquid fuel in the fuel tank enters the first pump 12 through the inlet 18. The first pump 12 has a pumping element 22 (shown in FIG. 9) that increases the pressure of the fuel therein and discharges the fuel under pressure through an outlet 24 of the first pump 12. The second pump 14 is arranged downstream of the first pump 12 and has an inlet 26 through which at least some of the fuel discharged from the first pump 12 flows. The second pump 14 also includes a pumping element 28 (shown in FIG. 9) that increases the pressure of the fuel in the second pump 14 and discharges the fuel through an outlet 30 of the second pump 14 for delivery to an engine. In at least some implementations, the pressure at the outlet 24 of the first pump 12 is lower than the pressure at the outlet 30 of the second pump 14. Both fuel pumps 12, 14 may include an electric motor 102, 104 (FIG. 9) and the pumping elements 22, 28 may include turbine type impellers, positive displacement gerotors, screws, gears or any desired pumping element.

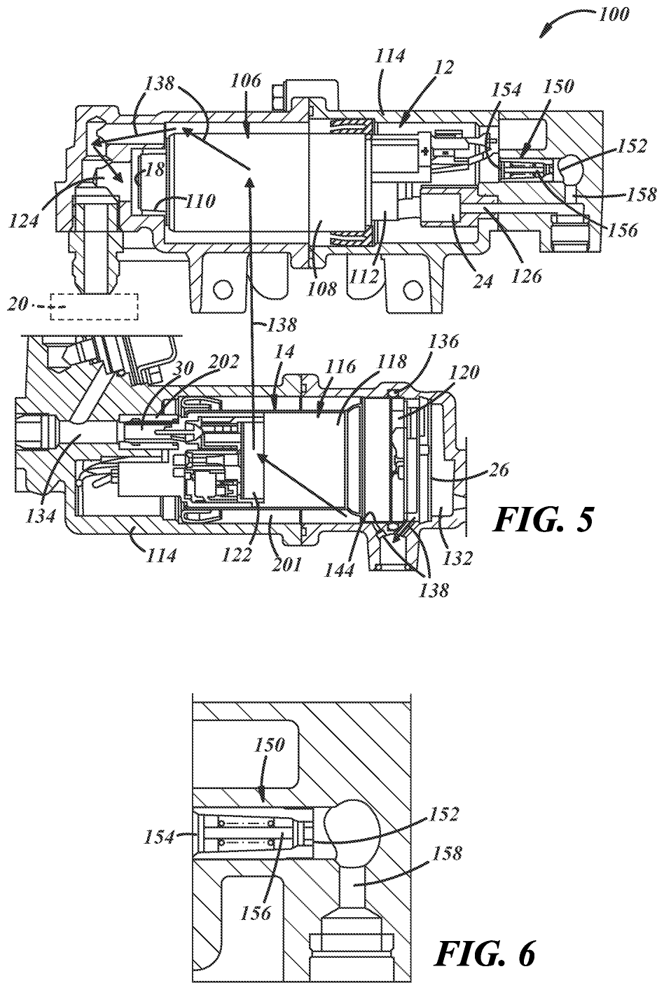

As shown in FIG. 5, the first pump 12 may have an exterior 106 defined by outer surfaces of an outer casing 108 surrounding its motor 102, an inlet end cap 110 sealed to the casing 108 and defining the first pump inlet 18, and an outlet end cap 112 sealed to the casing 108 and defining the first pump outlet 24. The first pump 12 may be received within the housing 114 which may surround at least part of the exterior of the first pump 12. The second pump 14 may similarly have an exterior 116 defined by outer surfaces of an outer casing 118 surrounding its motor 104, an inlet end cap 120 sealed to the casing 118 and defining the second pump inlet 26, and an outlet end cap 122 sealed to the casing 118 and defining the second pump outlet 30.

A first pump inlet chamber 124 may be provided between the inlet end cap 110 and the housing 114 and fuel therein may be drawn into the first pump inlet 18. An outlet chamber 126 or passage may be provided between the outlet end cap 112 and the housing 114 and fuel discharged from the first pump 12 may enter the first pump outlet chamber 126 en route to the second pump inlet 26. The first pump inlet chamber 124 may be sealed from the first pump outlet chamber 126 by a suitable seal which may be provided adjacent to the outlet 24 if desired.

The second pump 14 may be received within a housing that surrounds at least part of the exterior of the second pump 14. The housing in which the second pump 14 is received may be the same housing 114 in which the first pump 12 is received (with the pumps in at least partially separate chambers of the housing) or a different housing, as desired. The first pump outlet chamber 126 may be communicated with an inlet chamber 132 defined between the second pump 14 and the housing 114 in communication with the second pump inlet 26, or the first pump outlet 24 may be directly communicated with the second pump inlet chamber 132 or second pump inlet 26 directly. The second pump inlet chamber 132 may be sealed from and separate from a second pump outlet chamber 134 or passage in the housing 114 which may include fuel at the outlet pressure of the second pump 14. An o-ring or other seal 136 may be received between the exterior of the second pump 14 (e.g. the casing or inlet end cap) and the interior of the housing 114 to seal the second pump inlet chamber 132 from the second pump exterior chamber 201. A seal, such as a lathe cut seal 202, may be received in the housing 114 to seal the second pump outlet chamber 134 from the exterior chamber 201.

The second pump 14 and housing 114 may include a vapor vent 138 through which vapor or other gaseous matter received at or generated by the second pump 14 may be routed away from the pumping element 28 of the second pump 14. FIG. 8 shows a representative inlet end cap 120 for the second pump 14 that includes a pumping channel 140 and a vent opening 142 that is communicated with the pumping channel 140 and with the vapor vent 138. Vanes 143 (FIG. 9) on an impeller (which may comprise at least part of pumping element 28) may be moved relative to the pumping channel 140 to increase the pressure of fuel in the pumping channel, as is known in the art. Vapor in the fuel in the pumping channel 140 may tend to flow toward and through the vent opening 142 which extends through the end cap 120 to reduce the volume of vapor within the fuel being pumped and thereby increase the efficiency of the second pump 14. Such vapor is then routed out of the pumping channel 140, out of the second pump 14 through the vapor vent 138, which may include an opening in the housing 114 that communicates with the second pump exterior chamber 201 and which communicates through suitable passage(s) or conduit(s) with the inlet 18 of the first pump 12 (e.g. its inlet chamber 124). The first pump inlet chamber 124 is at a lower pressure than the second pump inlet chamber 132 and so the fluid will flow from the second pump inlet chamber 132 to the first pump inlet chamber 124. The vapor vent 138 is represented in FIG. 5 by a series of arrows leading from the second pump inlet to the first pump inlet chamber 124, which may communicate with a space or chamber between the first pump casing 108 and the housing 114. Likewise, part of the vapor vent 138 may include or extend through part of a space or chamber between the second pump casing 118 and the housing 114. The vapor vent 138 may be routed internally of the housing 114, externally such as by one or more tubes or conduits, a combination of these, or in any desired manner (e.g. through passages or spaces defined in adjacent bodies or the like).

The second pump inlet chamber 132 also includes liquid fuel. To limit the flow rate of liquid fuel from the second pump inlet chamber 132 to the first pump inlet chamber 124, which would reduce the efficiency of the second pump 14 and could unduly raise the pressure of the first pump inlet chamber 124 and reduce the efficiency of the first pump 12, a restriction 144 may be provided in the vapor vent 138. The restriction could be a reduced size orifice in the housing 114 and leading to the inlet chamber 124, a reduced sized portion of a passage or conduit in the vapor flow path (all of which may define the vapor vent 138) which may be formed directly in the material defining the passage or conduit, or within an insert placed in a passage between the housings. The restriction 144 may be sized to more freely flow gaseous matter but inhibit and limit the flow of liquid fuel therethrough. In at least some implementations, the restriction 144 may have a minimum cross-sectional flow area (taken perpendicular to the direction of fluid flow therethrough) of between 0.3 mm² and 2.0 mm². The restriction may enable the pressure of the vapor to increase sufficiently to flow to the first pump inlet chamber 124.

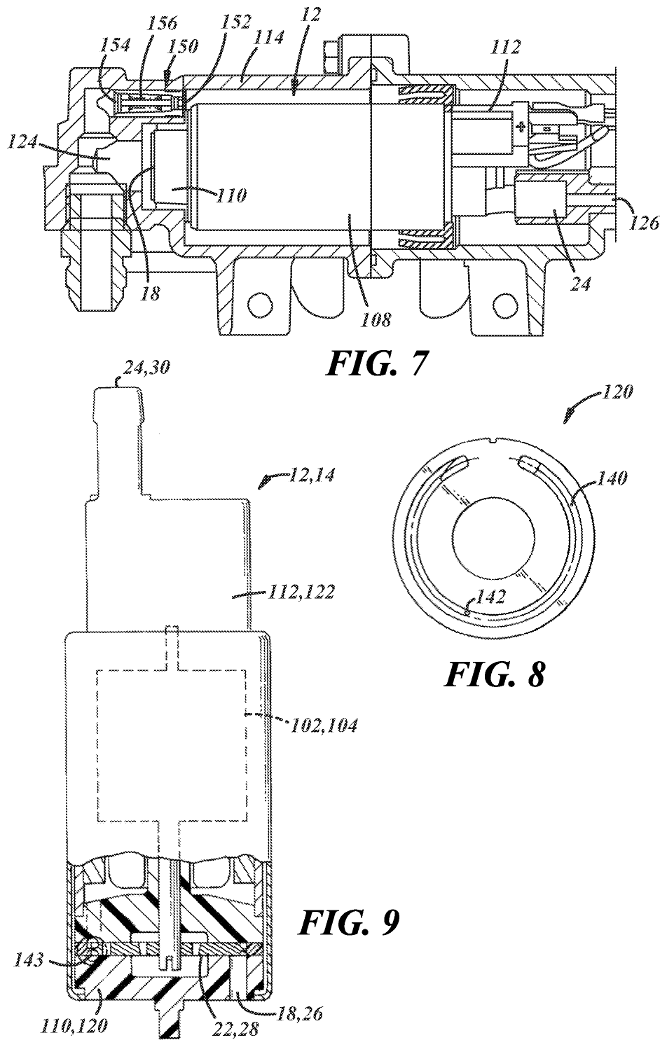

As shown in FIGS. 5 and 6, a pressure regulator 150 may be provided that has an inlet 152 in communication with the first pump outlet chamber 126, an outlet 154 in communication with the first pump inlet chamber 124 and a normally closed pressure responsive valve 156 between the inlet 152 and outlet 154. When a threshold pressure is exceeded in the first pump outlet chamber 126, the pressure regulator valve 156 opens to permit fluid in the outlet chamber 126 to flow through the valve 156 to the inlet chamber 124. In the example shown in FIG. 5, the inlet 152 is communicated with a branch passage 158 that receives fuel discharged from the first pump outlet 24. In the example shown in FIG. 7, the inlet 152 communicates with a chamber between the housing 114 and the exterior of the first fuel pump 12 and the regulator 150 is located adjacent to and the outlet 154 communicates with the first pump inlet chamber 124.

Thus, the fluid in the vapor vent 138 may be routed to the first pump inlet chamber 124 and gaseous matter may be entrained in liquid fuel and may condense back to liquid or be dispersed within the liquid to limit the volumetric flow rate of gaseous matter into the first pump 12 and to the second pump 14. Thus, the fuel system 100 has improved vapor handling capability and limits the flow rate of vapor from a first pump 12 to a second pump 14 to avoid, among other things, a vapor or air lock situation at the second pump 14 wherein too much gaseous matter is attempted to be pumped at any given time.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

As used in this specification and claims, the terms “for example,” “for instance,” “e.g.,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A fuel system, comprising:
a first pump having a first pump inlet, a first pump outlet and a first pump pumping element between the first pump inlet and first pump outlet;
a second pump having a second pump inlet, a second pump outlet and a second pump pumping element between the second pump inlet and second pump outlet; and
a filter module having a housing defining an interior, a filter received in the interior, a filter inlet through which fluid flows into the interior, a filter outlet from which fluid flows out of the interior, and a vent body received within the interior and having a passage and a vent orifice, wherein the filter is arranged so that fluid that enters the filter inlet flows through the filter before flowing out of the filter outlet and the interior includes an upper portion arranged above a lower portion relative to the force of gravity, and the passage communicates with the filter outlet and with the lower portion of the interior and the vent orifice communicates with the passage and with the upper portion of the interior.

2. The system of claim 1 wherein the vent orifice has a smaller flow area than does the passage.

3. The system of claim 2 wherein the passage opens into the interior at a location below a vertical midpoint of the interior, where the vertical midpoint is determined in the direction of the force of gravity.

4. The system of claim 2 wherein the vent orifice opens into the interior at a location above a vertical midpoint of the interior, where the vertical midpoint is determined in the direction of the force of gravity.

5. The system of claim 2 wherein the vent orifice has a cross-sectional area between 10 and 50 times smaller than the cross-sectional area of the passage.

6. The system of claim 1 wherein the filter is annular and wherein the filter inlet communicates directly with an outer surface of the filter and the filter outlet communicates directly with an inner surface of the filter.

7. The system of claim 6 wherein the vent body is tubular and received within a space defined by the inner surface of the filter.

8. The system of claim 6 wherein the vent body is secured to one or both of an upper wall of the housing and the inner surface of the filter.

9. The system of claim 7 wherein the vent orifice extends through a sidewall of the vent body.

10. A fuel system, comprising:
a first pump having a first pump inlet, a first pump outlet and a first pump pumping element between the first pump inlet and first pump outlet;
a second pump having a second pump inlet, a second pump outlet and a second pump pumping element between the second pump inlet and second pump outlet; and
a vent passage communicating with the second pump inlet and either or both of the first pump inlet and the first pump outlet, wherein fluid flows into the first pump inlet, the first pump pumping element increases the pressure of the fluid in the first pump and that fluid is discharged from the first pump outlet, and fluid discharged from the first pump outlet flows to the second pump inlet.

11. The system of claim 10 which also includes a housing surrounding at least part of the first pump and defining a first pump inlet chamber with which the first pump inlet communicates, and a housing surrounding at least part of the second pump and defining a second pump inlet chamber with which the second pump inlet communicates, and wherein the vent passage communicates with the second pump inlet chamber.

12. The system of claim 11 wherein the vent passage communicates with the first pump inlet chamber.

13. The system of claim 11 wherein the housing that defines part of the first pump inlet chamber also defines part of a first pump outlet chamber into which fluid is discharged from the first pump outlet, and wherein the vent passage communicates with the first pump outlet passage.

14. The system of claim 12 wherein the housing that defines part of the first pump inlet chamber also defines part of a first pump outlet chamber into which fluid is discharged from the first pump outlet, and wherein the system also includes a pressure regulator having an inlet communicated with the first pump outlet chamber, an outlet communicated with the first pump inlet chamber and a valve between the inlet of the pressure regulator and the outlet of the pressure regulator, and wherein the valve is closed when the pressure within the first pump outlet chamber is below a threshold and the valve is open when the pressure within the first pump outlet chamber is above a threshold.

15. The system of claim 11 wherein the housing surrounding at least part of the first pump and defining a first pump inlet chamber with which the first pump inlet communicates, is the same housing as the housing surrounding at least part of the second pump and defining a second pump inlet chamber with which the second pump inlet communicates.

16. The system of claim 10 wherein a restriction is provided in the vent passage providing a portion of the vent passage with a smaller flow area that inhibits the flow of liquid fuel therethrough.

17. The system of claim 16 wherein the restriction has a minimum cross-sectional flow area, taken perpendicular to the direction of fluid flow therethrough, of between 0.3 mm² and 2.0 mm².
